(19) United States
(12) Patent Application Publication
(10) Pub. No.: US 2026/0153227 A1
(43) Pub. Date: Jun. 4, 2026

(54) INTERCHANGEABLE DECORATIVE LIGHT STRING WITH THREADED COLLAR COUPLING MECHANISM

(71) Applicants: Matthew Roznovsky, New Braunfels, TX (US); Robert Sparks, New Braunfels, TX (US); Lacey Roznovsky, New Braunfels, TX (US)

(72) Inventors: Matthew Roznovsky, New Braunfels, TX (US); Robert Sparks, New Braunfels, TX (US); Lacey Roznovsky, New Braunfels, TX (US)

(21) Appl. No.: 19/407,113

(22) Filed: Dec. 3, 2025

Related U.S. Application Data
(63) Continuation-in-part of application No. 18/911,241, filed on Oct. 10, 2024.

(51) Int. Cl. F21V 17/12; F21S 4/10; F21V 23/02; F21V 23/06; F21Y 115/10; H05B 45/20; H05B 47/19

(52) U.S. Cl. CPC F21V 17/12; F21S 4/10; F21V 23/02; F21V 23/06; H05B 45/20; H05B 47/19; F21Y 2115/10

(57) ABSTRACT

A decorative light string with a threaded collar coupling mechanism enables secure, tool-free interchange of bulbs and branch lines. A collar is positioned over an inserted component and screws into socket threads, providing robust mechanical and electrical connection.

### RELATED APPLICATION

This application claims priority to U.S. patent application Ser. No. 18/911,241 filed Oct. 10, 2024 which claims priority to U.S. Provisional Patent Application 63/543,337 filed Oct. 10, 2023, each of which is incorporated herein by reference in its entirety.

### FIELD

The invention relates to decorative light strings and, more particularly, to a threaded-collar coupling mechanism that allows any socket on any string to interchangeably accept either an LED bulb or another light string (branch string) in a tool-free and secure manner.

### BACKGROUND

Traditional light strings use fixed sockets, latches, or simple plugs that are prone to disconnecting under stress or require tools for removal. These limit customization and reliability. There is a need for a tool-free, secure, and reversible coupling mechanism that enables interchangeability of bulbs and branch lines while resisting vibration, tension, and environmental forces.

### SUMMARY

The present invention is a decorative light string system featuring a threaded collar coupling mechanism that secures a bulb or branch line within a socket. The mechanism comprises: a socket with a threaded attachment site; a bulb or branch line with a base or connector configured for insertion into the socket; a collar with internal threads the collar positioned axially over the inserted base/connector and engages external threads on the socket via rotation to lock the component in electrical and mechanical contact. The collar can be captive to the male connector or to the female connector. In certain configurations this collar mechanism enables tool-free interchangeability, secure retention, and repeated use without wear or damage. The system supports customization by allowing any socket to accept either a bulb or a branch line, secured by the collar.

The lines are connected through the sockets (directly connected) or through one or more branch lines (indirectly connected), secured via the collar mechanism. In certain aspects, 1, 2, 3, 4, 5, 6, 7, 8, 9, 10, 11, 12, 13, 14, 15, 16, 17, 18, 19, 20 or more spur/branch lines can be connected to a line via a socket. In certain aspects, branch lines are not directly connected to a power source but are connected to a power source directly or indirectly through a first line.

The Interchangeable Decorative Light String System offers a highly adaptable, energy-efficient, and cost-effective solution for customizable decorative lighting arrangements. Its innovative features, including the collar-based coupling mechanism, empower users to create unique lighting displays while maximizing energy conservation and connection security, making it a significant advancement in the field of decorative lighting.

Certain embodiments are directed to a kit comprising an unassembled light string system. The kit may include one or more lines, the lines having 0, 1, 2, 3, 4, 5, 6, 7, 8, 9, 10 or more interchangeable sockets equipped with collar-based coupling mechanisms. The kit may include 1, 2, 3, 4, 5, 6, 7, 8, 9, 10, 11, 12, 13, 14, 15, 16, 17, 18, 19, 20, or more lines, the lines having 0, 1, 2, 3, 4, 5, 6, 7, 8, 9, 10 or more interchangeable sockets with collar mechanisms. In other aspects the kit can include a power supply or an adapter/connector for connection to a power source. The kit may also include a plurality of bulbs. In certain aspects the bulbs are light emitting diodes (LED) bulbs or the like, with bases compatible with the collar-based coupling.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a composition and/or method that “comprises” a list of elements (e.g., components or features or steps) is not necessarily limited to only those elements (or components or features or steps) but may include other elements (or components or features or steps) not expressly listed or inherent to the chemical composition and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith. When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a composition and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1A and FIG. 1B is a perspective view and front view of a connection assembly on a branch line with a male connector 101 a collar 102 in a fully engaged position with adapter 103.

FIG. 1C is a side view of the assembly with a branch line with a male connector 101 a collar 102 in a fully engaged position with adapter 103.

FIG. 1D is a cross-section view along the A-A plane of FIG. 1C with the branch line male connector 101 interacting with female plug/connector 104, and a secured collar 102 in a fully engaged position with adapter 103.

FIG. 1E and FIG. 1F is an exploded view of the assembly with an adapter FIG. 1E and socket FIG. 1F branch line connector or male connector 101 inserted into the adapter 103 or socket 105 having female plug 104, and the assembly secured by collar 102.

FIG. 2A-FIG. 2D illustrates various views of a bulb assembly.

FIG. 2A is a front view of a bulb assembly embodiment showing: a bulb 206 in a socket 205 with secured by collar 202.

FIG. 2B is a side view of the bulb assembly embodiment showing the bulb 206 inserted into the socket 205 with the collar 202 securing the assembly.

FIG. 2C is a side cross-sectional view A-A of the bulb assembly showing collar 202 rotationally engaged with socket threads. The male portion of the blub inserted in female plug 204, establishing a secure electrical and mechanical connection.

FIG. 2D is an exploded view of the assembly detailing the interface between the bulb 206, light emitting diode (LED) 207, LED base or male connector 208, collar 202, female plug 204 and socket 205.

### DESCRIPTION

The following discussion is directed to various embodiments of the invention. The term “invention” is not intended to refer to any specific embodiment or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment and not intended to imply that the scope of the disclosure, including the claims, is limited to that embodiment.

### I. Collar-Based Coupling Mechanism

Certain embodiments are directed to a collar coupling mechanism for decorative light strings. An assembly can include: an insertion cavity accepting an LED bulb base or branch line connector; external threads circumferentially disposed around the socket or adapter opening; a collar with internal threads matching socket threads, the collar having circumferential freedom to screw on onto the socket or adapter without twisting a branch line and in certain aspects having axial freedom to slide over inserted component. The collar-based coupling mechanism is configured for rotational engagement to lock via threading. Operation includes inserting bulb base or branch connector into socket; positioning collar with the inserted component; rotating collar to engage threads, drawing it onto socket or adapter and compressing the connection. Removal can be accomplished by reversing the process. The collar may include knurling or grips for manual operation, with no tools required for engagement and disengagment.

Universal Line Architecture—In certain embodiments all lines can be identical and interchangeable One feature that can be incorporated in the present invention is that every light string manufactured under this system can be identical. There is no dedicated “master/main line” and no dedicated “branch/spur line” until the moment the user decides which string will be plugged into the power adapter/transformer. Any string can serve as the initial string connected to the power source (and thereby become the “main line”) or can be connected to any socket of another string (and thereby become a “branch line”). This complete interchangeability dramatically reduces manufacturing cost, inventory complexity, and user confusion.

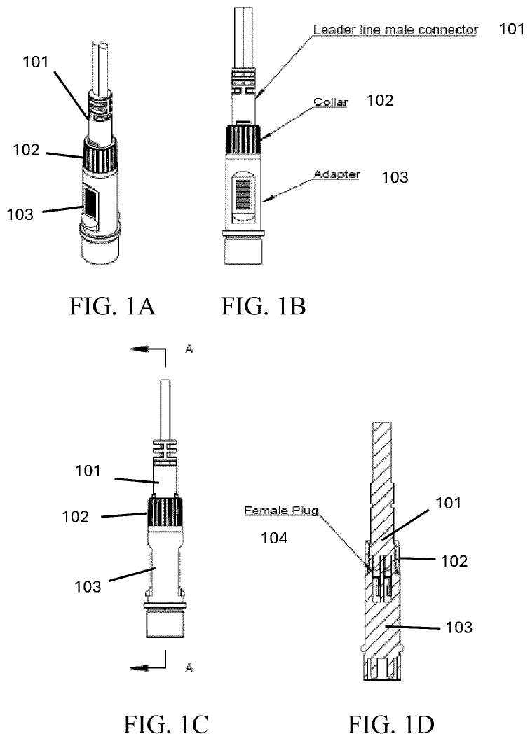

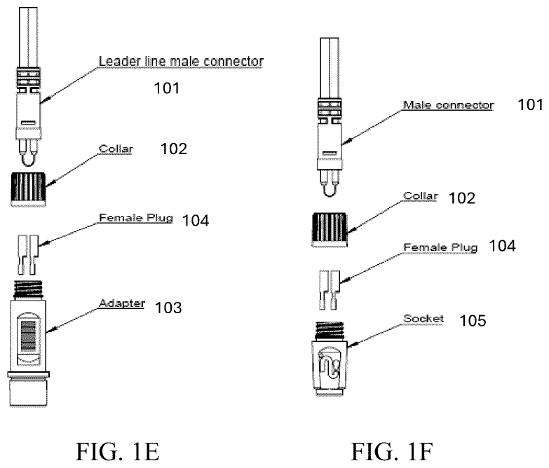

Power Adapter/Transformer Connector. In certain embodiments the only component that is not a light string is the power adapter 103 shown in FIGS. 1A-1F. The power adapter 103 is a short fitting that terminates in the same standardized male connector 101 and threaded collar 102 that is used everywhere else in the system. The opposite end of the power adapter 103 is a conventional plug or low-voltage barrel connector that mates with the user's transformer or power supply. The power adapter 103 is therefore nothing more than a mechanical and electrical bridge that converts a standard power source into the universal collar connector format used throughout the entire system. It need not be part of any light string and is not used to join two light strings together.

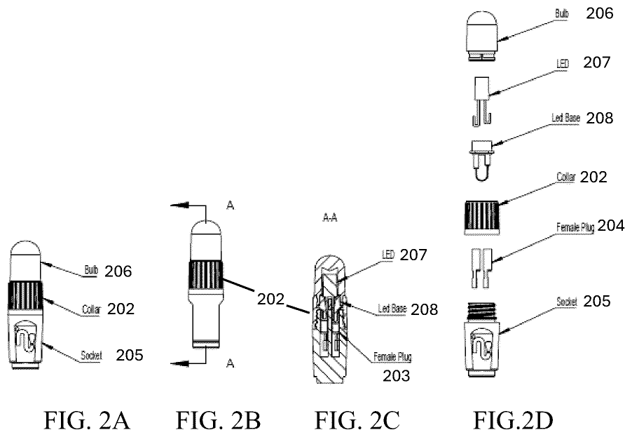

Socket and Collar Coupling Mechanism. In certain embodiments every socket 105, 205 on every light string comprises: (a) a socket body with an opening surrounded by external threads, (b) electrical contacts inside the socket body, and (c) a rotatable threaded collar 102, 202 that that can be captive to the socket body (i.e., it cannot be removed or lost during normal use) yet is free to rotate and move axially a limited distance. Both LED bulbs (FIG. 2) and the male connector 101 terminating any other light string (FIG. 1) can be smooth (unthreaded) and dimensionally identical where they insert into the socket. To install either a bulb or another light string, the user simply pushes the male portion into any empty socket and hand-tightens the captive collar 102/202. Unscrewing the collar releases the component so it may be swapped for the other type. No tools are required, and the wire is never twisted because the collar spins freely around it.

Weatherproofing (Optional Embodiment). In an outdoor-rated embodiment, an elastomeric O-ring or gasket is compressed between the collar and the socket body when the collar is tightened, providing at least an IP65 ingress protection rating.

Illustrated Socket and Collar Assembly (FIGS. 1A-1F). Referring now to FIG. 1A perspective view, FIG. 1B front view, and FIG. 1C side view: a socket or adapter assembly is integrally formed or mounted along a main line. The adapter or socket includes an insertion cavity (not labeled) dimensioned to receive either a bulb base 104 or a branch line connector 105 (see FIG. 1E). External threads are circumferentially disposed around the opening of the socket or adapter. A collar 102 having internal threads (not visible in FIG. 1A) is captive to the socket or adapter.

FIG. 1D is a cross section along A-A of FIG. 1C and depicts the fully secured configuration wherein the collar 102 is rotated and advanced downward, threadedly engaging the external threads of the adapter 103. The internal threads of the collar 103 draw the collar axially, compressing the adapter 103 against internal electrical contacts of the branch line (male connector) with the adapter female plug to establish robust mechanical retention and low-resistance electrical connection. The collar 102 can include external knurling for manual grip during rotation.

FIG. 1E and FIG. 1F illustrate an exploded view of an adapter and a socket embodiment respectively, the interchangeable nature of the adapter 103 or socket 105 with a branch line connector 101. In FIG. 1E, the connector 101—terminating a spur/branch line—is inserted into the adapter 103 or socket 105 which can be previously occupied by a bulb. In FIG. 1F, the collar 102 is engaged over the connector 101, securing the branch line to the main line using the coupling mechanism. This interchangeability enables dynamic reconfiguration of lighting arrangements without tools or permanent fixtures.

Bulb Embodiment and Interface (FIGS. 2A-2D). FIG. 2A (front view), FIG. 2B (a side view), and FIG. 2D (cross section) comprises: a light-emitting bulb 206 (e.g., LED) secured to a socket 205; the socket 205 with external threads; a sliding collar 202 having internal threads and external knurling for manual operation; and electrical contacts (male connector or LED base 208 engaged with female plug 204) within the socket cavity configured to mate with contacts on the base. In certain embodiments, the collar is captive to the socket via a retaining lip or flange (not shown), preventing loss during component interchange. The knurling facilitates tool-free operation in wet or gloved conditions, and the thread pitch and material (e.g., UV-stabilized polycarbonate) are selected to withstand repeated cycles without wear.

Sockets can be distributed along a main line. Each is configured to accept either a bulb or a branch line connector. Electrical contacts within the socket align with corresponding contacts on the inserted component. The collar mechanism provides securement regardless of component type.

Branch lines terminate in a connector compatible with the socket. Once inserted and secured by the collar, the branch line is powered via the main line. Branch lines may include additional sockets with identical collar mechanisms.

A main line connects to a power source and includes one or more sockets with the collar mechanism. The line supports parallel or series electrical configurations.

Master/main Line or master/main string: This is the primary component of the light string, which can be connected to a power source. The master/main line can be designed with different variations in number and spacing of sockets and/or bulb sockets equipped with collar-based coupling mechanisms. In certain aspects the wire or chord of the master/main line is compatible with tap connectors.

Spur/branch Lines or spur/branch string: These are secondary lines that typically do not have a direct power source but are designed to connect to the master/main line directly or indirectly at the points where interchangeable bulbs or accessory attachments are located. Spur/branch lines can be added or removed as needed for customization. The spur/branch lines have a spur/branch line connector configured to interact with and connect to a socket in the master/main line or a second spur/branch line, or an accessory attachment, secured by the collar mechanism. The spur/branch connector is inserted in an empty socket-connecting the spur/branch line with the master/main line or another spur/branch line.

Sockets: Each socket on the master/main line or a spur/branch line includes a collar-based coupling mechanism for easy removal and replacement of a bulb or a spur/branch line. The mechanism involves inserting the bulb base or branch connector into the socket, then sliding the collar over the inserted component and screwing it into the threaded attachment site on the socket. This secures the component while allowing for swift, tool-free interchangeability.

In certain aspects the bulb is a light emitting diode (LED). Light-emitting diodes (LEDs) come in various types, each designed for specific applications and optimized for different characteristics. Some common types of LEDs include: Red LEDs: Emit red light and are one of the earliest and most common types of LEDs. Green LEDs: Emit green light and are also widely used. Blue LEDs: Emit blue light and are crucial for creating white light in combination with phosphors. White LEDs: Typically created by using blue LEDs with a phosphor coating or by combining red, green, and blue LEDs. They are versatile and used in various applications, including general lighting. RGB LEDs: Contain red, green, and blue LED chips in a single package, allowing for a wide range of colors by mixing different intensities of these colors. Organic LEDs (OLEDs) use organic materials to emit light. Quantum Dot LEDs (QLEDs) utilize quantum dots to enhance color accuracy and brightness. MicroLEDs consist of tiny individual LEDs, typically less than 100 micrometers in size.

LED by Special Features: Smart LEDs are equipped with wireless communication capabilities, these LEDs can be controlled remotely, often used in smart lighting systems. High-Efficiency LEDs are designed for maximum energy efficiency and long life spans.

Operation Controller: Controlling light strings has evolved with technology, offering various methods tailored to different needs and levels of complexity. In certain aspects a control mechanism is coupled proximally where the entire string is under control of a single controller or individual controllers are couple to various main lines or spur/branch lines to control various components of the light assembly individually. The most basic method involves plug-in controllers where lights can be plug into a controller that is then plugged into the power source. Other controller are remote controls using IR or RF technology, these allow users to change settings from a distance, including color, brightness, and patterns. Wi-Fi and Smart Controls can be integrated with smart home systems like Alexa, Google Home, or dedicated apps, these lights can be controlled via voice commands or smartphones, offering features like scheduling, custom light shows, and even synchronization with music. For professional setups, DMX (Digital Multiplex) controllers provide precise control over individual lights or sections, commonly used in stage lighting to create complex visual effects. Bluetooth Controls are similar to Wi-Fi but often with a shorter range, Bluetooth enables control through paired devices, which is useful for more localized adjustments without needing an internet connection. Each method offers different levels of convenience, customization, and automation, catering to everything from simple home decorations to elaborate professional displays.

The design of the decorative light string allows for the connection of multiple lines to a single or multiple power source(s). This feature enhances energy efficiency and reduces the number of power sources needed, making the light string environmentally friendly and cost-effective.

Ingress Protection (IP) ratings for lighting, or any electrical equipment, indicate the level of protection against intrusion, mainly by foreign bodies like dust and moisture. The IP codes typically relevant for lighting and what they signify include the following: (i) First Digit (Protection against solids): 0—No protection, 1—Protection against objects greater than 50 mm, like hands, 2−Protection against objects greater than 12.5 mm, like fingers, 3—Protection against objects greater than 2.5 mm, like tools, wires, etc., 4—Protection against objects greater than 1 mm, like most wires, 5—Dust-protected. Limited ingress of dust is allowed, but it won't interfere with the operation of the equipment, 6—Dust-tight, no ingress of dust; (ii) Second Digit (Protection against liquids): 0—No protection, 1—Protection against vertically falling drops of water, like condensation, 2—Protection against direct sprays of water up to 15° from vertical, 3—Protection against sprays up to 60° from vertical, 4—Protection against water splashed from any direction, 5—Protection against low-pressure water jets from any direction, 6—Protection against strong jets of water (e.g., for use on ship decks), 7—Protection against the effects of immersion between 15 cm and 1 m, 8—Protection against long periods of immersion under pressure. Common IP ratings include IP20 (basic protection against access to hazardous parts by hands, no protection against water), IP44 (commonly used for indoor lighting, protects against objects larger than 1 mm and water splashed from any direction), IP54 (often seen in outdoor lighting, adds dust protection to the above), IP65 (suitable for outdoor or harsh environments, offering full dust protection and resistance to water jets), IP66 (similar to IP65 but with better resistance to water jets, suitable for more extreme conditions), and IP67/IP68 (used in underwater lighting or fixtures that might be submerged, like in swimming pool lights or very harsh industrial environments). When choosing lighting, consider the environment where the fixture will be installed to ensure it has an appropriate IP rating. For instance, outdoor or wet areas like bathrooms would need higher water ingress protection, while indoor office lighting might only need basic protection against solid objects.

In certain embodiments the light string can have a particular Ingress Protection (IP) rating, such as a IP65 rating. This rating is used to characterize lighting, particularly for outdoor or industrial applications, because it provides specific protection against environmental factors. Ingress Protection (IP) code characterizes the protection against dust, and protection against water. The appropriate rating provides that the lights have a durability and safety and is essential for ensuring that lights used outdoors or in challenging environments remain safe, reliable, and functional over time. An IP65 rating for lighting indicates the level of protection the lighting fixture provides against the ingress of dust and water. In a rating of IP65 the first digit (6) means the lighting is totally protected against dust. This means no ingress of dust is allowed, providing a very high level of protection against solid particles. The second digit (5) indicates that the lighting can withstand water projected from a nozzle against the enclosure from any direction. This protection level is suitable for exposure to low-pressure jets of water from any direction, which might be encountered in outdoor conditions where rain or water jets might be present.

An IP65 rating ensures the fixture can handle dusty or very humid conditions without failing due to dust accumulation or water ingress and is suitable for a variety of outdoor applications, like garden lights, pathway lights, or any external architectural lighting where weather exposure is expected but not extreme water submersion or high-pressure cleaning. When considering lighting for specific environments, especially outdoors or in areas with potential water exposure, an IP65 rated light would be a reliable choice for ensuring longevity and performance under adverse conditions. For environments where more severe water exposure is expected (like continuous submersion or high-pressure washdown), a higher rating like IP67, IP68, or even IP69K may be needed for the most rigorous conditions involving high-temperature water jets or steam cleaning. In certain aspects a light string can have a IP rating of IP20, IP44, IP54, IP65, IP66, IP67, or IP68.

Connectors can be in various configurations and multiple connectors can be used within a particular light string assembly. For connecting light strings, especially in the context of present invention, there are several types of connectors and methods that can be used. End-to-End Connectors having male connector-to-female Plugs are simple connectors where one string of lights ends in a male plug that can fit into the female socket of another string. Male splitters are male plugs that split into multiple female sockets, allowing you to connect several strings from one outlet or another string. Adapters are described that can be used if you need to extend or connect strings where you might have for example two male or two female ends, or desire to connect to a string at a position that does not have a connector. Clip connector or alligator clips can be used where you might need to quickly connect or disconnect lights without permanent fixtures.

1. A decorative light string comprising:
(i) a first line configured to connect with a power source;
(ii) one or more branch points having a male or female connector distributed along the first line;
(iii) one or more additional lines having a male or female connector half with a collar configured to reversibly secure a connection between a male connector and a female connector to connect with the first line or a subsequent line by being electrically coupled to the first line or an additional line;
the sockets are configured to receive either a bulb or a line with a threaded collar that slides over an inserted bulb base or a connector and screws into a threaded attachment site on the socket for reversibly securing the bulb or branch line.

2. The decorative light string of claim 1, wherein the sockets are configured to connect a line to another line using the collar mechanism for secure fixation.

3. The decorative light string of claim 1, further comprising a power source.

4. The decorative light string of claim 4, wherein the power source can power a plurality of LED lines simultaneously.

5. The decorative light string of claim 1, wherein the first or subsequent line has 1, 5, 10, 20, 30 or more sockets with collar mechanisms.

6. The decorative light string of claim 1, wherein the additional line has 1, 5, 10, 20, 30, or more sockets with collar mechanisms.

7. The decorative light string of claim 1, wherein the collar-based coupling mechanism includes ergonomic grips for manual screwing and unscrewing without tools.

8. The decorative light string of claim 1, wherein the light string or system is configured to provide warm light, neutral light, or cool light.

9. The decorative light string of claim 1, wherein the light string or system is configured to provide light at a light temperature of 2700K to 6500K.

10. The decorative light string of claim 1, further comprising a control system.

11. The decorative light string of claim 1, wherein the control system is a Zigbee control system.

12. A decorative light string system comprising:
(a) a plurality of light strings, each light string having a wire and a plurality of sockets spaced along the wire, each socket comprising:
(i) a socket body with external threads surrounding an opening,
(ii) electrical contacts within the opening, and
(iii) a threaded collar that is captive to and non-removable from the socket body while remaining freely rotatable thereon and having limited axial travel;
(b) a plurality of LED bulbs, each having an unthreaded base configured to be inserted into any socket of any light string; and
(c) a power adapter having a first end configured to connect to an external power source and a second end terminating in an unthreaded male connector identical to the bases of the LED bulbs and surrounded by a captive threaded collar; wherein any socket on any light string interchangeably accepts and securely retains, via hand-rotation of its captive threaded collar, either one of the LED bulbs, the male connector of another identical light string, or the male connector of the power adapter, thereby enabling complete tool-free interchangeability of all strings and bulbs without dedicated main or branch strings.

13. The system of claim 1, wherein tightening the captive threaded collar compresses an elastomeric sealing member to provide at least an IP65 ingress protection rating.

14. The system of claim 1, wherein the captive threaded collar includes knurling or wing features for hand tightening without tools.

15. The system of claim 1, wherein each light string contains 5, 10, 15, 20, 25, 30, 40, 50, 70, or 100 sockets.

16. The system of claim 1, wherein the LED bulbs are tunable-white bulbs capable of color temperatures from 2700 K to 6500 K.

17. The system of claim 1, wherein at least some of the LED bulbs or the power adapter include wireless control circuitry selected from Zigbee, Bluetooth, or Wi-Fi.

18. The system of claim 1, wherein the captive threaded collar is retained on the socket body by an inward flange engaging a circumferential groove on the socket body.

19. The system of claim 1, wherein the male connectors and bulb bases are coaxial connectors.
